(19) United States
(12) Patent Application Publication
(10) Pub. No.: US 2024/0006895 A1
(43) Pub. Date: Jan. 4, 2024

(54) BATTERY CHARGING METHOD AND DEVICE AND ELECTRONIC APPARATUS

(71) Applicant: Lenovo (Beijing) Limited, Beijing (CN)

(72) Inventor: Yonghua YAN, Beijing (CN)

(21) Appl. No.: 18/184,358

(22) Filed: Mar. 15, 2023

(30) Foreign Application Priority Data
Jun. 30, 2022 (CN) 202210758920.4

(51) Int. Cl. H02J 7/00; H02J 7/34

(52) U.S. Cl. CPC H02J 7/0019; H02J 7/34; H02J 7/00714; H02J 7/0047

(57) ABSTRACT

A battery charging method includes obtaining an external charging power supply, charging a main battery according to a reference strategy based on the external charging power supply, and charging a backup battery according to a follow strategy based on the external charging power supply to maintain a target parameter of the backup battery in a charging process based on the external charging power supply and a target parameter of the main battery in the charging process based on the external charging power supply in a target range. The backup battery and the main battery are connected in parallel. The target parameter represents battery power.

### CROSS-REFERENCE TO RELATED APPLICATION

This application claims priority to Chinese Patent Application No. 202210758920.4, filed on Jun. 30, 2022, the entire content of which is incorporated herein by reference.

### TECHNICAL FIELD

The present disclosure relates to the database field and, more particularly, to a battery charging method, a device, and an electronic apparatus.

### BACKGROUND

An electronic apparatus can be designed to be powered by dual batteries taking into consideration the internal space of the apparatus and/or apparatus battery life. In many situations, in the electronic apparatus, since a main battery and a backup battery have different dimensions, capacities, and models, voltages of the two batteries can be unbalanced when the two batteries are charging. Thus, a safety issue can occur in a subsequence battery discharge process.

### SUMMARY

Embodiments of the present disclosure provide a battery charging method. The method includes obtaining an external charging power supply, charging a main battery according to a reference strategy based on the external charging power supply, and charging a backup battery according to a follow strategy based on the external charging power supply to maintain a target parameter of the backup battery in a charging process based on the external charging power supply and a target parameter of the main battery in the charging process based on the external charging power supply in a target range. The backup battery and the main battery are connected in parallel. The target parameter represents battery power.

Embodiments of the present disclosure provide a battery charging device, including a power supply acquisition module and a charging control module. The power supply acquisition module is configured to obtain an external charging power supply. The charging control module is configured to charge a main battery according to a reference strategy based on the external charging power supply and charge a backup battery according to a follow strategy based on the external charging power supply to maintain a target parameter of the backup battery in a charging process based on the external charging power supply and a target parameter of the main battery in the charging process based on the external charging power supply in a target range. The backup battery and the main battery are connected in parallel. The target parameter represents battery power.

Embodiments of the present disclosure provide an electronic apparatus, including a processor and a memory. The memory stores executable program instructions that, when executed by the processor, cause the processor to obtain an external charging power supply, charge a main battery according to a reference strategy based on the external charging power supply, and charge a backup battery according to a follow strategy based on the external charging power supply to maintain a target parameter of the backup battery in a charging process based on the external charging power supply and a target parameter of the main battery in the charging process based on the external charging power supply in a target range. The backup battery and the main battery are connected in parallel. The target parameter represents battery power.

In the above technical solution, embodiments of the present disclosure provide a battery charging method, a battery charging device, and an electronic apparatus. The method includes obtaining an external charging power supply, charging a main battery according to a reference strategy based on the external charging power supply, and charging a backup battery according to a follow strategy based on the external charging power supply to maintain a target parameter of the backup battery in a charging process based on the external charging power supply and a target parameter of the main battery in the charging process based on the external charging power supply in a target range. The backup battery and the main battery are connected in parallel. The target parameter represents battery power. When the battery is charging in the above solution, the backup battery can be controlled to charge following the main battery to ensure that the power of the backup battery and the power of the main battery are maintained in a consistent or similar state in the charging process. Thus, a safety issue caused when the voltage of the backup battery is too high relative to the voltage of the main battery in a discharging process can be avoided.

### BRIEF DESCRIPTION OF THE DRAWINGS

FIG. 1 illustrates a schematic diagram of a dual battery charging structure according to embodiments of the present disclosure.

FIG. 2 illustrates a schematic flowchart of a battery charging method according to embodiments of the present disclosure.

FIG. 3 illustrates a schematic flowchart of a backup battery charging method according to embodiments of the present disclosure.

FIG. 4 illustrates a schematic flowchart of another battery charging method according to embodiments of the present disclosure.

FIG. 5 illustrates a schematic flowchart of a battery charging method according to embodiments of the present disclosure.

FIG. 6 illustrates a schematic diagram showing a corresponding relationship between a target parameter difference range and a target charging current according to embodiments of the present disclosure.

FIG. 7 illustrates a schematic structural diagram of a battery charging device according to embodiments of the present disclosure.

FIG. 8 illustrates a schematic structural diagram of an electronic apparatus according to embodiments of the present disclosure.

### DETAILED DESCRIPTION OF THE EMBODIMENTS

The technical solutions of embodiments of the present disclosure are described in detail below in connection with the accompanying drawings of embodiments of the present disclosure. Described embodiments are only some embodiments of the present disclosure, not all embodiments. All other embodiments obtained by those of ordinary skill in the art without creative effort are within the scope of the present disclosure.

Embodiments of the present disclosure can be applied to an electronic apparatus. A product form of the electronic apparatus cannot be limited by the present disclosure. The electronic apparatus can include but is not limited to a smartphone, a tablet computer, a wearable apparatus, a personal computer (PC), and a netbook. The electronic apparatus can be selected as needed.

To better understand the implementation of a battery charging method of the present disclosure, an application structure can be described first. The battery structure described in the specification can only be used to assist in understanding the battery charging method. The structure of the battery can only be a basic illustration and cannot limit a specific structure of the battery module in an actual application.

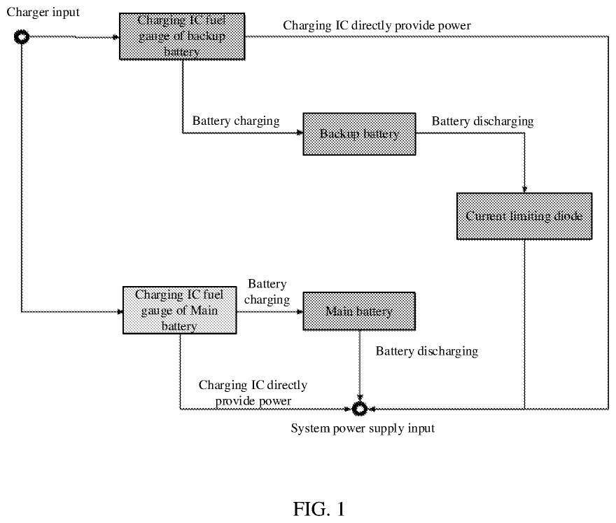

FIG. 1 illustrates a schematic diagram of a dual battery charging structure according to embodiments of the present disclosure. As shown in FIG. 1, a power supply assembly of the electronic apparatus includes two batteries, such as a main battery and a backup battery. The two batteries are connected in parallel. Each battery includes an independent charging IC fuel gauge, which can be configured to obtain a battery status of a corresponding battery in real-time and also control the charging of the battery. When the battery is connected to a power supply, the charging IC fuel gauge can be configured to control the charging of the battery and control to provide power directly to the system when the main battery and/or the backup battery cannot satisfy the system power supply requirement.

A current limiting diode can be a unidirectional current limiting diode. Since the main battery is responsible for providing power to the system, and the backup battery can only assist the main battery to provide power to the system together when the main battery cannot satisfy the system power supply requirement, the current limiting diode can only allow the backup battery to provide power to the system/main battery. The current limiting diode does not allow the main battery to provide power to the backup battery when the voltage of the main battery is higher than the voltage of the backup battery to prevent unnecessary power consumption.

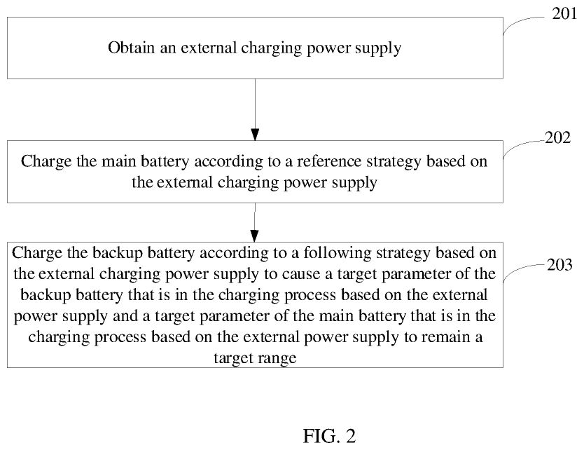

FIG. 2 illustrates a schematic flowchart of a battery charging method according to embodiments of the present disclosure. As shown in FIG. 2, the battery charging method includes the following processes.

At 201, an external charging power supply is obtained.

The external charging power supply can be a wired charging power supply, such as a charger with a charging wire or a wireless charger, which is not limited to the present disclosure.

At 202, the main battery is charging according to a reference strategy based on the external charging power supply.

The reference strategy can be an original charging strategy of the main battery configured by the system. Since the main battery is a main structure for providing power to the system, a charging requirement of the main battery should be considered and satisfied first. Moreover, a charging process of the main battery may need to be ensured to be not affected by other factors. Therefore, in the battery charging method of embodiments of the present disclosure, a charging process of the backup battery can be dynamically adjusted based on a charging condition of the main battery. That is, the charging process of the backup battery can be performed along with the charging process of the main battery.

At 203, the backup battery is charging according to a follow strategy based on the external charging power supply to cause a target parameter of the backup battery that is in the charging process based on the external power supply and a target parameter of the main battery that is in the charging process based on the external power supply to remain a target range. The backup battery and the main battery are connected in parallel. The target parameter represents battery power.

The target parameter can represent the battery power. The target parameter can be a dynamically changing value along with the charging process. In some embodiments, the target parameter can be directly the battery power or the voltage of the battery. The higher the voltage of the battery is, the higher the corresponding battery power is. Thus, based on a performance parameter of the battery, a corresponding relationship between the voltage of the battery and the battery power can be determined. Thus, the battery power can be determined according to the voltage of the battery. For example, a voltage of a fully charged battery can be 5V. That is, when the voltage of the battery is 5V, the battery power can be 100%. When the voltage is 4.5V, the battery power can be 80%.

In some embodiments, the main battery can be the main structure responsible for providing power to the system. Thus, in an operation process, the main battery can always provide power to the system. The backup battery can assist the main battery to provide power to the system when the main battery cannot further provide power to the system. In the present disclosure, the capacities and/or sizes of the main battery and the backup battery can be same or different.

The target parameter of the backup battery in the charging process and the target parameter of the main battery in the charging process can remain in a target range to cause the power of the backup battery and the main battery to remain substantially consistent. Thus, a battery with a higher voltage or a higher power can be prevented from reversely filling a voltage/current of a battery with a lower voltage or a lower power.

Meanwhile, the charging processes of the main battery and the backup battery can be different due to different conditions of the two batteries such as capacity, size, and manufacturers. In some embodiments, the capacity of the main battery can be larger than the capacity of the backup battery. Thus, during the charging process, the power and voltage of the backup battery can increase faster compared to the main battery. However, when the voltage of the backup battery is much higher than the main battery, over-current can occur when the backup battery is discharging. Therefore, the target parameter of the backup battery in the charging process and the target parameter of the main battery in the charging process can remain in the target range. In a dual battery charging process, when the battery power is balanced, the dual batteries that are connected in parallel can be ensured to be safely discharged.

In summary, since the target parameter is a dynamically changing value, the control for charging the backup battery can be also adjusted in real-time. Thus, by dynamically adjusting a charging speed of the backup battery, the backup battery can be charging along with the main battery. Thus, the power/voltage of the backup battery in the charging process can be balanced in a single direction. Meanwhile, in the charging process, the voltage of the backup battery can be ensured not to exceed the voltage of the main battery too much, which can avoid the over-current condition of the backup battery in the discharging process.

In embodiments of the present disclosure, when the battery is charging, the backup battery can be controlled to be charging with the main battery to ensure that the power of the backup battery and the main battery can remain in a status of consistent or similar in the charging process. Thus, the safety issue caused because the voltage of the backup battery is much higher than the voltage of the main battery can be avoided in the discharging process.

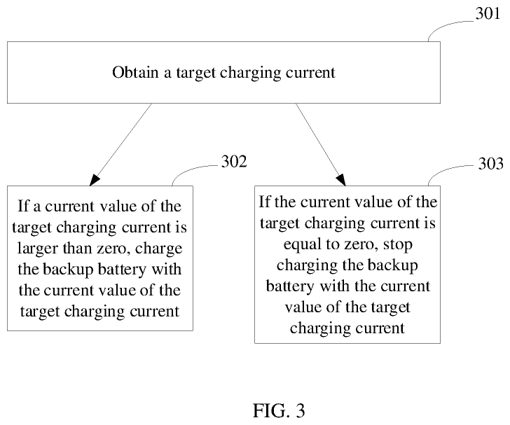

FIG. 3 illustrates a schematic flowchart of a backup battery charging method according to embodiments of the present disclosure. As shown in FIG. 3, charging the backup battery according to the follow strategy based on the external charging power supply includes the following processes.

At 301, a target charging current is obtained to proceed to process 302 or process 303.

Since the power and the voltage of the main battery and the backup battery are changed in real-time in the charging process, the target charging current of the backup battery that is charging along with the main battery can also be a value that is dynamically changed in real- time. The target charging current can be determined based on a voltage difference or a power difference between the backup battery and the main battery, which is described below.

At 302, if a current value of the target charging current is larger than zero, the backup battery is charging with the current value of the target charging current.

When the current value of the target charging current is greater than zero, the backup battery can need to be continuously charging according to the target charging current. In some embodiments, the value of the target charging current can be determined by maintaining the target parameter of the backup battery and the target parameter of the main battery in a target range. For example, when the power of the backup battery is larger than the power of the main battery, the changing speed of the backup battery can be slowed down. That is, the charging current of the backup battery can be lowered to reduce the difference between the power of the main battery and the power of the backup battery.

At 303, if the current value of the target charging current is equal to zero, the backup battery is stopped from being charging with the current value of the target charging current.

When the current value of the target charging current is equal to zero, the difference between the power of the backup battery and the power of the main battery can be indicated to be large. To maintain the target parameter of the backup battery and the target parameter of the main battery in the target range, the charging of the backup battery should be paused. Thus, the power of the main battery can catch up with the power of the backup battery as fast as possible.

Based on the above, in some embodiments, obtaining the target charging current can include obtaining a first target charging current and a second target charging current, determining a minimum value of the first target charging current and the second target charging current as the target charging current to satisfy a charging balance of the main battery and the backup battery.

As described above, the target parameter can represent the battery power. However, the parameter capable of representing the battery power may not be unique. For example, the target parameter can be the battery power or the voltage of the battery. Thus, based on different target parameters, different target charging currents can be obtained. Thus, to make the control of maintaining the target parameter of the backup battery and the target parameter of the main battery to be in the target range more accurate, the minimum value of the plurality of target charging currents can be used as the target changing current to reduce the difference between the power of the main battery and the power of the backup battery as soon as possible.

In some other embodiments, obtaining the target charging current can include obtaining the first target charging current and the second target charging current and determining a maximum value of the first target charging current and the second target charging current as the target charging current to satisfy the charging efficiency of the backup battery.

In embodiments of the present disclosure, by considering the overall charging efficiency, after different target charging currents are obtained based on different target parameters, the maximum value of the plurality of target charging currents can be used as the target charging current. Thus, by maintaining the target parameter of the backup battery and the target parameter of the main battery in the target range, the backup battery can be charging at a highest charging speed. The maximum efficiency of the charging system can be achieved.

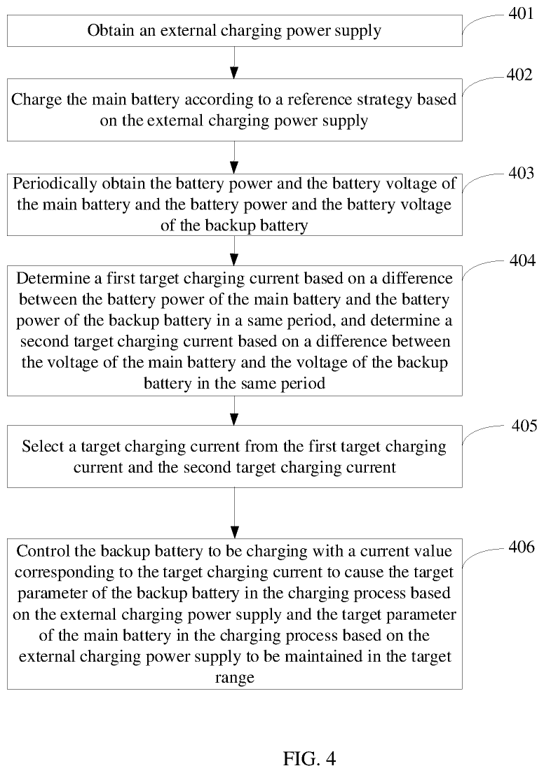

FIG. 4 illustrates a schematic flowchart of another battery charging method according to embodiments of the present disclosure. As shown in FIG. 4, the battery charging method includes the following processes.

At 401, an external charging power supply is obtained.

At 402, the main battery is charging according to a reference strategy based on the external charging power supply.

At 403, the battery power and the battery voltage of the main battery and the battery power and the battery voltage of the backup battery are periodically obtained.

The power and voltages of the main battery and the backup battery are changing in real-time during the charging process. Thus, to constantly maintain the target parameter of the backup battery and the target parameter of the main battery in the target range, corresponding detection and control may need to be performed periodically. To ensure control precision, a detection period cannot be set too large and can be set according to the requirements of the actual application scenario.

At 404, a first target charging current is determined based on a difference between the battery power of the main battery and the battery power of the backup battery in a same period, and a second target charging current is determined based on a difference between the voltage of the main battery and the voltage of the backup battery in the same period.

That is, the first target charging current can be determined based on the difference between the power of the backup battery and the power of the main battery in the same period. The second target charging current can be determined based on the difference between the voltage of the backup battery and the voltage of the main battery in the same period. The first target charging current and the second target charging current can belong to the same period.

At 405, a target charging current is selected from the first target charging current and the second target charging current.

A manner for selecting the target charging current can be determined according to a requirement of an application scenario. If the application scenario has a high control precision requirement, a minimum value of the first target charging current and the second target charging current can be determined as the target charging current. If the application scenario has a high charging efficiency requirement, a maximum value of the first target charging current and the second target charging current can be determined as the target charging current.

At 406, the backup battery is controlled to be charging with a current value corresponding to the target charging current to cause the target parameter of the backup battery in the charging process based on the external charging power supply and the target parameter of the main battery in the charging process based on the external charging power supply to be maintained in the target range.

In embodiments of the present disclosure, the charging speed of the backup battery can be periodically and dynamically adjusted to cause the backup battery to be charging along with the main battery. Thus, the electric quantity/voltage of the backup battery can be unidirectionally balanced relative to the main battery in the charging process.

In embodiments of the present disclosure, a difference between the power of the backup battery and the power of the main battery can correspond to different power difference ranges. The different power difference ranges can correspond to different charging currents. A difference between the voltage of the backup battery and the voltage of the main battery can correspond to different voltage difference ranges. The different voltage difference ranges can also correspond to different charging currents.

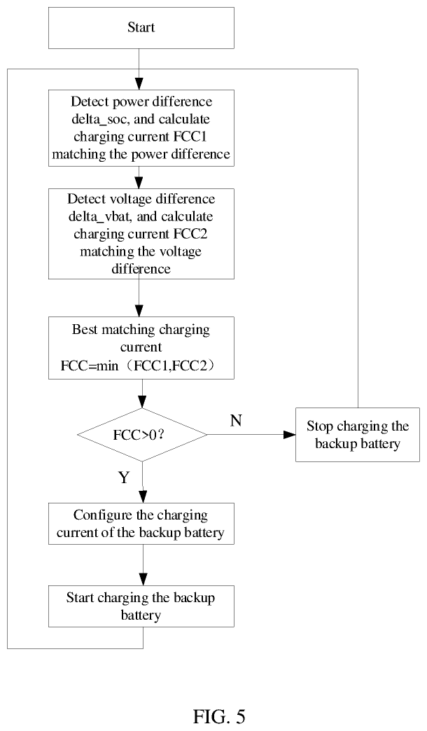

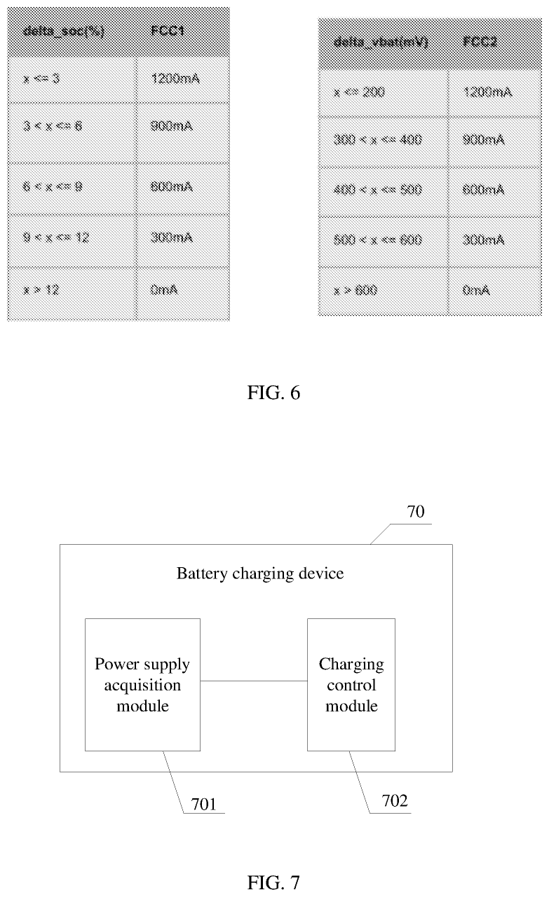

FIG. 5 illustrates a schematic flowchart of a battery charging method according to embodiments of the present disclosure. FIG. 6 illustrates a schematic diagram showing a corresponding relationship between a target parameter difference range and a target charging current according to embodiments of the present disclosure. As shown in FIG. 5 and FIG. 6, the battery charging process includes the following processes.

In algorithm control, voltage vbat and power soc of the main battery and voltage vbat and power soc of the backup battery are periodically obtained, and the differences are calculated.
delta_vbat=flip_vbat-base_vbat; and
delta_soc=flip_soc-base_soc.

Charging current upper limit FCC of the backup battery is calculated by using delta_vbat and delta_soc as input conditions.

Thus, the charging speed of the backup battery can be limited. A negative feedback control closed loop can be formed with delta_vbat and delta_soc as inputs and FCC as an output. Thus, the method that the backup battery can be automatically charging balanced following the main battery can be realized.

The corresponding relationship shown in FIG. 6 is only an example in embodiments of the present disclosure. The division of the difference range (delta_soc or delta_vbat) of the specific target parameter (battery power or battery voltage) and the values of the target charging currents (FCC1 and FCC2) corresponding to different difference ranges can be determined based on actual situations and are not limited.

For a simple description, method embodiments are described as a series of action combinations. Those skilled in the art should understand that the present disclosure is not limited to a sequence of the described actions, because some processes can be performed in another sequence or simultaneously according to the present disclosure. In addition, those skilled in the art should also understand that the embodiments described in the specification are merely some embodiments of the present disclosure, and the actions and modules involved may not be necessary for the present disclosure.

The methods are described in detail in embodiments of the present disclosure. The methods of the present disclosure can be implemented by various types of devices. Thus, the present disclosure also provides a device, which is described in detail below.

FIG. 7 illustrates a schematic structural diagram of a battery charging device 70 according to embodiments of the present disclosure. As shown in FIG. 7, the battery charging device 70 includes a power supply acquisition module 701 and a charging control module 702.

The power supply acquisition module 701 can be configured to obtain an external charging power supply.

The charging control module 702 can be configured to charge the main battery according to the reference strategy based on the external charging power supply and charge the backup battery according to the follow strategy based on the external charging power supply to maintain the target parameter of the backup battery in the charging process based on the external charging power supply and the target parameter of the main battery in the charging process based on the external charging power supply in the target range. The backup battery and the main battery can be connected in parallel. The target parameter can represent the battery power.

In the solution of the present disclosure, when the battery is charging, the backup battery is controlled to be charging along with the main battery to ensure that the power of the backup battery and the power of the main battery are maintained in a consistent or similar state in the charging process. Thus, a safety issue caused when the voltage of the backup battery is too high relative to the main battery can be avoided in the discharging process.

In some embodiments, the charging control module can include a charging parameter acquisition module and a charging control sub-module. The charging parameter acquisition module can be configured to obtain a target charging current. The charging control sub-module can be configured to charge the backup battery using the current value of the target charging current when the current value of the target charging current is greater than zero, and stop charging the backup battery with the current value of the target charging current when the current value of the target charging current is equal to zero.

In some embodiments, the charging parameter acquisition module can be configured to obtain the first target charging current and the second target charging current and determine the minimum value of the first target charging current and the second target charging current as the target charging current to satisfy the charging balance of the main battery and the backup battery.

In some embodiments, the charging parameter acquisition module can be configured to obtain the first target charging current and the second target charging current and determine the maximum value of the first target charging current and the second target charging current as the target charging current to meet the charging efficiency of the backup battery.

In some embodiments, the battery charging device can further include a parameter detection module. The parameter detection module can be configured to periodically obtain the power and the voltage of the main battery and the power and the voltage of the backup battery. The first target charging current can be a charging current determined based on the difference value between the power of the backup battery and the power of the main battery in the same period. The second target charging current can be a charging current determined based on the difference between the voltage of the backup battery and the voltage of the main battery in the same period. The first target charging current and the second target charging current can belong to the same period.

In some embodiments, the difference between the power of the backup battery and the power of the main battery can correspond to different power difference ranges, and the different power difference ranges can correspond to different charging currents. The difference between the voltage of the backup battery and the main battery can correspond to different voltage difference ranges, and the different voltage difference ranges can correspond to different charging currents.

The battery charging device of embodiments of the present disclosure can include a processor and a memory. The power supply acquisition module, the charging control module, the charging parameter acquisition module, the charging control sub-module, and the parameter detection module can be stored in the memory as program modules that, when executed by the processor, cause the processor to implement corresponding functions.

The processor can include a kernel. The kernel can call the corresponding program module from the memory. One or more kernels can be provided. The revisit data can be processed by adjusting the parameter of the one or more kernels.

The memory can include volatile memory in a computer-readable medium, random access memory (RAM), and/or nonvolatile memory, such as read-only memory (ROM) or flash RAM. The memory can include at least one memory chip.

Embodiments of the present disclosure further provide a computer-readable storage medium, which can be directly loaded into the internal memory of a computer and include software codes. The computer program can be loaded into the computer and executed to implement the processes of any of the above battery charging method embodiments.

Embodiments of the present disclosure further provide a computer program product, which can be directly loaded into the internal memory of the computer and can include the software codes. The computer program can be loaded into the computer and executed to implement the processes of any of the above battery charging method embodiments.

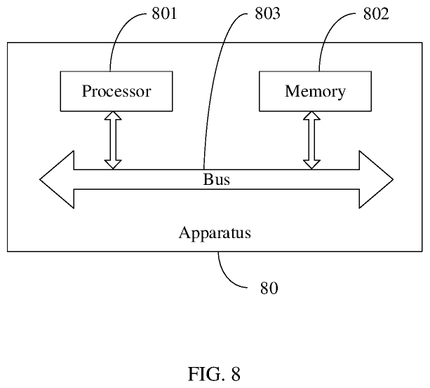

Further, embodiments of the present disclosure provide an electronic apparatus. FIG. 8 illustrates a schematic structural diagram of an electronic apparatus 80 according to embodiments of the present disclosure. As shown in FIG. 8, the electronic apparatus 80 includes at least one processor 801, at least one memory 802 connected to the processor, and a bus 803. The processor can communicate with the memory through the bus. The processor can be configured to call the program instructions in the memory to execute the battery charging methods.

Embodiments of the present disclosure are described in a progressive manner. Each embodiment focuses on differences from other embodiments. The same and similar parts among embodiments can refer to each other. For the device of embodiments of the present disclosure, since the device corresponds to the methods of embodiments of the present disclosure, the description can be simple. The relevant part can be referred to in the description of the method part.

In the present specification, terms such as first and second are merely used to distinguish one entity or operation from another entity or operation without necessarily requiring or implying any actual relationship or order between such entities or operations. Also, the terms “comprising,” “including,” or any other variation thereof, are intended to cover a non-exclusive inclusion. Thus, a process, method, article, or apparatus that includes a list of elements does not include only those elements but can include other elements not expressly listed or inherent to such process, method, article, or apparatus. Without further limitation, an element defined by the phrase “comprising a” does not exclude the presence of other identical elements in a process, method, article, or apparatus that includes the element.

The steps of the method or algorithm described in connection with embodiments of the present disclosure can be directly implemented by hardware, a software module executed by a processor, or a combination thereof. The software module can be stored in random access memory (RAM), memory, read-only memory (ROM), electrically programmable ROM, electrically erasable programmable ROM, registers, hard disk, a removable disk, a CD-ROM, or any other form of storage medium.

The above description of embodiments of the present disclosure can enable those skilled in the art to make or use the present disclosure. Various modifications to embodiments of the present disclosure can be apparent to those skilled in the art. The generic principles defined here can be implemented in other embodiments without departing from the spirit or scope of the present disclosure. Thus, the present disclosure is not limited to the embodiments of the present specification but needs to conform to the widest scope of the principle and the novel feature of the present disclosure.

What is claimed is:

1. A battery charging method, comprising:
obtaining an external charging power supply;
charging a main battery according to a reference strategy based on the external charging power supply; and
charging a backup battery according to a follow strategy based on the external charging power supply to maintain a target parameter of the backup battery in a charging process based on the external charging power supply and a target parameter of the main battery in the charging process based on the external charging power supply in a target range, the backup battery and the main battery being connected in parallel, and the target parameter representing battery power.

2. The battery charging method of claim 1, wherein charging the backup battery according to the follow strategy based on the external charging power supply includes:
obtaining a target charging current;
in response to a current value of the target charging current being larger than zero, charging the backup battery with the current value of the target charging current; and
in response to the current value of the target charging current being equal to zero, stopping charging the backup battery with the current value of the target charging current.

3. The battery charging method of claim 2, wherein obtaining the target charging current includes:
obtaining a first target charging current and a second target charging current; and
determining a minimum value of the first target charging current and the second target charging current as the target charging current to satisfy a charging balance of the main battery and the backup battery.

4. The battery charging method of claim 2, wherein obtaining the target charging current includes:
obtaining a first target charging current and a second target charging current; and
determining a maximum value of the first target charging current and the second target charging current as the target charging current to satisfy charging efficiency of the backup battery.

5. The battery charging method according to claim 4, further comprising:
periodically obtaining power and voltage of the main battery and power and voltage of the backup battery;
wherein:
the first target charging current is a charging current determined based on a difference between the power of the backup battery and the power of the main battery in a same period;
the second target charging current is a charging current determined based on a difference between the voltage of the backup battery and the voltage of the main battery in the same period; and
the first target charging current and the second target charging current belong to the same period.

6. The battery charging method according to claim 5, wherein:
the difference between the power of the backup battery and the power of the main battery corresponds to different power difference ranges, and the different power difference ranges correspond to different charging currents; and
the difference between the voltage of the backup battery and the voltage of the main battery corresponds to different voltage difference ranges, and the different voltage difference ranges correspond to the different charging currents.

7. A battery charging device comprising:
a power supply acquisition module configured to obtain an external charging power supply; and
a charging control module configured to:
charge a main battery according to a reference strategy based on the external charging power supply; and
charge a backup battery according to a follow strategy based on the external charging power supply to maintain a target parameter of the backup battery in a charging process based on the external charging power supply and a target parameter of the main battery in the charging process based on the external charging power supply in a target range, the backup battery and the main battery being connected in parallel, and the target parameter representing battery power.

8. The battery charging device of claim 7, wherein the charging control module includes:
a charging parameter acquisition module configured to obtain a target charging current; and
a charging control sub-module configured to:
in response to a current value of the target charging current being larger than zero, charge the backup battery with the current value of the target charging current; and
in response to the current value of the target charging current being equal to zero, stop charging the backup battery with the current value of the target charging current.

9. The battery charging device according to claim 8, wherein the charging parameter acquisition module is further configured to:
obtain a first target charging current and a second target charging current; and
determine a minimum value of the first target charging current and the second target charging current as the target charging current to satisfy a charging balance of the main battery and the backup battery.

10. The battery charging device of claim 8, wherein the charging parameter acquisition module is further configured to:
obtain a first target charging current and a second target charging current; and
determine a maximum value of the first target charging current and the second target charging current as the target charging current to satisfy charging efficiency of the backup battery.

11. The battery charging device according to claim 10, further comprising a parameter detection module configured to:
periodically obtain power and voltage of the main battery and power and voltage of the backup battery;
wherein:
the first target charging current is a charging current determined based on a difference between the power of the backup battery and the power of the main battery in a same period;
the second target charging current is a charging current determined based on a difference between the voltage of the backup battery and the voltage of the main battery in the same period; and
the first target charging current and the second target charging current belong to the same period.

12. The battery charging device according to claim 11, wherein:
the difference between the power of the backup battery and the power of the main battery corresponds to different power difference ranges, and the different power difference ranges correspond to different charging currents; and
the difference between the voltage of the backup battery and the voltage of the main battery corresponds to different voltage difference ranges, and the different voltage difference ranges correspond to the different charging currents.

13. An electronic apparatus, comprising:
a processor; and
a memory storing executable program instructions that, when executed by the processor, cause the processor to:
obtain an external charging power supply;
charge a main battery according to a reference strategy based on the external charging power supply; and
charge a backup battery according to a follow strategy based on the external charging power supply to maintain a target parameter of the backup battery in a charging process based on the external charging power supply and a target parameter of the main battery in the charging process based on the external charging power supply in a target range, the backup battery and the main battery being connected in parallel, and the target parameter representing battery power.

14. The electronic apparatus of claim 13, wherein the processor is further configured to:
obtain a target charging current;
in response to a current value of the target charging current being larger than zero, charge the backup battery with the current value of the target charging current; and
in response to the current value of the target charging current being equal to zero, stop charging the backup battery with the current value of the target charging current.

15. The electronic apparatus of claim 14, wherein the processor is further configured to:
obtain a first target charging current and a second target charging current; and
determine a minimum value of the first target charging current and the second target charging current as the target charging current to satisfy a charging balance of the main battery and the backup battery.

16. The electronic apparatus of claim 14, wherein the processor is further configured to:
obtain a first target charging current and a second target charging current; and
determine a maximum value of the first target charging current and the second target charging current as the target charging current to satisfy charging efficiency of the backup battery.

17. The electronic apparatus according to claim 16, wherein the processor is further configured to:
periodically obtain power and voltage of the main battery and power and voltage of the backup battery;
wherein:
the first target charging current is a charging current determined based on a difference between the power of the backup battery and the power of the main battery in a same period;
the second target charging current is a charging current determined based on a difference between the voltage of the backup battery and the voltage of the main battery in the same period; and
the first target charging current and the second target charging current belong to the same period.

18. The electronic apparatus according to claim 17, wherein:
the difference between the power of the backup battery and the power of the main battery corresponds to different power difference ranges, and the different power difference ranges correspond to different charging currents; and
the difference between the voltage of the backup battery and the voltage of the main battery corresponds to different voltage difference ranges, and the different voltage difference ranges correspond to the different charging currents.
